(19) United States
(12) Patent Application Publication
(10) Pub. No.: US 2010/0300707 A1
(43) Pub. Date: Dec. 2, 2010

(54) FIRE BARRIER

(76) Inventor: Dimitrios Kolios, North Bay (CA)

Correspondence Address: TAROLLI, SUNDHEIM, COVELL & TUMMINO L.L.P., 1300 EAST NINTH STREET, SUITE 1700, CLEVELAND, OH, 44114, US

(21) Appl. No.: 12/808,912

(22) PCT Filed: Dec. 18, 2008
(86) PCT No.: PCT/CA2008/002221

§ 371 Date: Jun. 17, 2010

Related U.S. Application Data
(60) Provisional application No. 61/015,527, filed on Dec. 20, 2007.

(51) Int. Cl. A62C 2/00

(52) U.S. Cl. 169/48

(57) ABSTRACT

A barrier apparatus for arresting the spread of fires is disclosed. The barrier apparatus comprises a flexible panel and a support apparatus. The panel is of fire-resistant material and has a first end portion and a second end portion, spaced-apart from one another. The support apparatus is for causing said panel to assume, in use, an upright position whereat it extends upwardly from said first end portion to said second end portion.

### FIELD OF THE INVENTION

The present invention relates to the field of fire protection.

### BACKGROUND OF THE INVENTION

Wildfires are a serious problem in many regions. In areas prone to wildfires, conventional fire management policies consist of the creation of firebreaks, to wit, areas of reduced vegetation between areas/structures to be protected and flammable vegetation. While this technique can be effective, it requires space and imposes limitations in terms of aesthetics.

### SUMMARY OF THE INVENTION

A barrier apparatus for arresting the spread of fires forms one aspect of the invention. The barrier apparatus comprises a flexible panel and a support apparatus. The panel is constructed of fire-resistant material and has a first end portion and a second end portion, spaced-apart from one another. The support apparatus is for causing said panel to assume, in use, an upright position whereat it extends upwardly from said first end portion to said second end portion.

According to another aspect of the invention, the apparatus can comprise mounting apparatus for operatively securing the first end portion of said panel at least adjacent to the ground in use.

According to other aspects of the invention, the panel can be imperforate, the panel can be fabric and the fabric can be woven from aromatic nylon.

According to another aspect of the invention, the support apparatus can comprise a plurality of balloons and a plurality of guys. The balloons are buoyant in air and tethered to the second end portion of the panel in use. The guys each have, in use, a free end secured to the second end portion of the panel and a fixed end operatively secured to the ground.

According to another aspect of the invention, each guy can unspool from a respective ground-secured winch to the free end thereof in use.

According to another aspect of the invention, the support apparatus can comprise a plurality of support poles each, in use, being orientated upright, having a ground-engaging base and having a top portion from which the panel is suspended.

According to another aspect of the invention, the barrier apparatus can further comprise mounting apparatus for operatively securing the first end portion of said panel at least adjacent to the ground in use.

According to another aspect of the invention, the barrier apparatus can further comprise a plurality of guys each, in use, having a free end secured to the second end portion of the panel and a fixed end operatively secured to the ground.

According to another aspect of the invention, each guy can unspool in use from a respective ground-secured winch to the free end thereof.

According to another aspect of the invention, in use, the support apparatus can selectively cause said panel to assume said upright position.

According to another aspect of the invention, the barrier apparatus can further comprise mounting apparatus for operatively securing the first end portion of said panel at least adjacent to the ground in use.

According to another aspect of the invention, the support apparatus can cause said panel to assume said upright position in response to the presence of smoke or heat.

According to another aspect of the invention, the mounting apparatus can comprise a roller, rotatably mounted in use to the ground, about which the panel can be wound and from which the panel is unwound when the support apparatus causes said panel to assume said upright position.

According to another aspect of the invention, the support apparatus can comprise a plurality of balloons. The balloons are tethered to the second end portion of the panel and adapted to, in use, selectively buoy the second end portion of the panel to urge the panel towards the upright position.

According to another aspect of the invention, the barrier apparatus can further comprise a plurality of winches each secured to the ground in use and adapted to unspool, as said panel assumes said upright position, a respective guy coupled to the second end portion of the panel.

According to other aspects of the invention, the support apparatus can comprise a plurality of support poles each, in use, being orientated upright, having a ground-engaging base and having a top portion from which the panel is suspended, and the support poles can extend telescopically to cause the panel to assume the upright position.

According to another aspect of the invention, the barrier apparatus can further comprise a plurality of winches each secured to the ground in use and adapted to unspool, as said panel assumes said upright position, a respective guy coupled to the second end portion of the panel.

According to another aspect, the barrier apparatus can comprise water spray/sprinkler apparatus for automatically directing water onto the panel in response to heat or fire.

Other advantages, features and characteristics of the present invention, as well as methods of operation and functions of the related elements of the structure, will become apparent upon consideration of the following detailed description and the appended claims with reference to the accompanying drawings, the latter being briefly described hereinbelow.

### BRIEF DESCRIPTION OF THE DRAWINGS

FIG. 1 is a perspective view of a barrier apparatus according to an exemplary embodiment of the invention, in use;

FIG. 2 is an overhead view of the apparatus of FIG. 1;

FIG. 3 is a perspective view of a barrier apparatus according to a second exemplary embodiment, in use;

FIG. 4 is a side, partial, cross-sectional view of the structure of FIG. 3, with the barrier apparatus shown in a storage configuration;

FIG. 5 is a perspective view, similar to FIG. 1, of a barrier apparatus according to a third exemplary embodiment of the invention, in use;

FIG. 6 is an overhead view of the apparatus of FIG. 6;

FIG. 7 is a side, cross-sectional view of a portion of the structure of FIG. 5;

FIG. 8 is a view of the structure of FIG. 7 in a retracted position;

FIG. 9 is a view, similar to FIG. 3, of a fourth exemplary embodiment of the invention, in use;

FIG. 10 is a view, similar to FIG. 4, of the structure of FIG. 9;

FIG. 11 is an enlarged view of area 11 in FIG. 1; and

FIG. 12 is a view of a fifth exemplary embodiment of the invention, in use.

### DETAILED DESCRIPTION

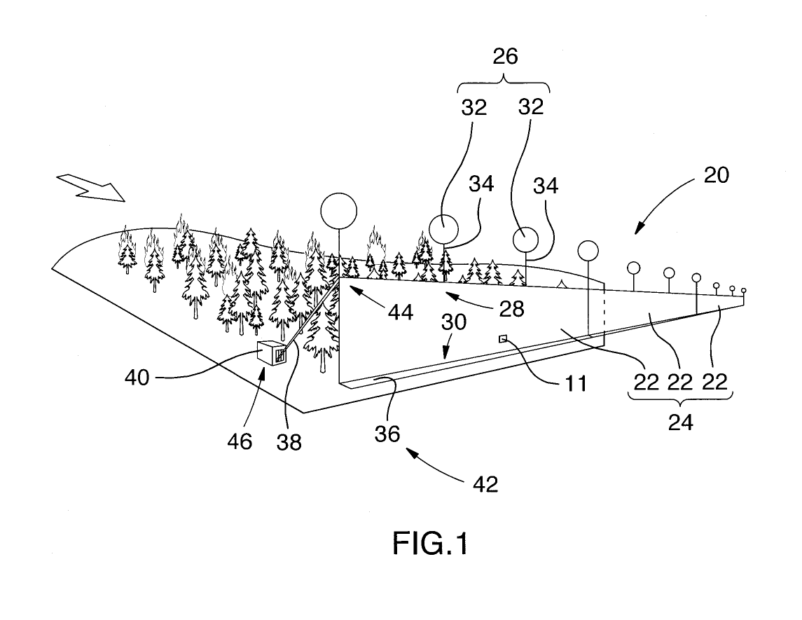

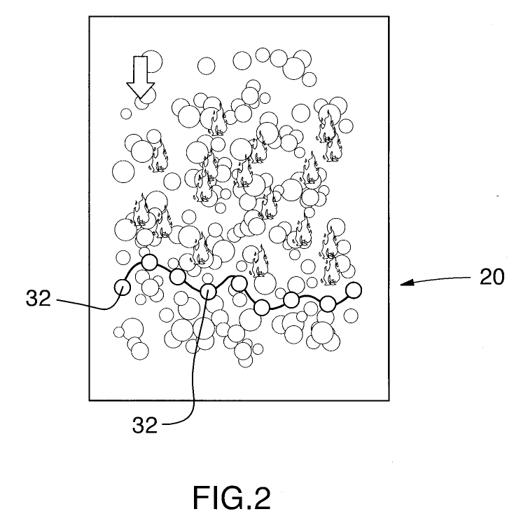

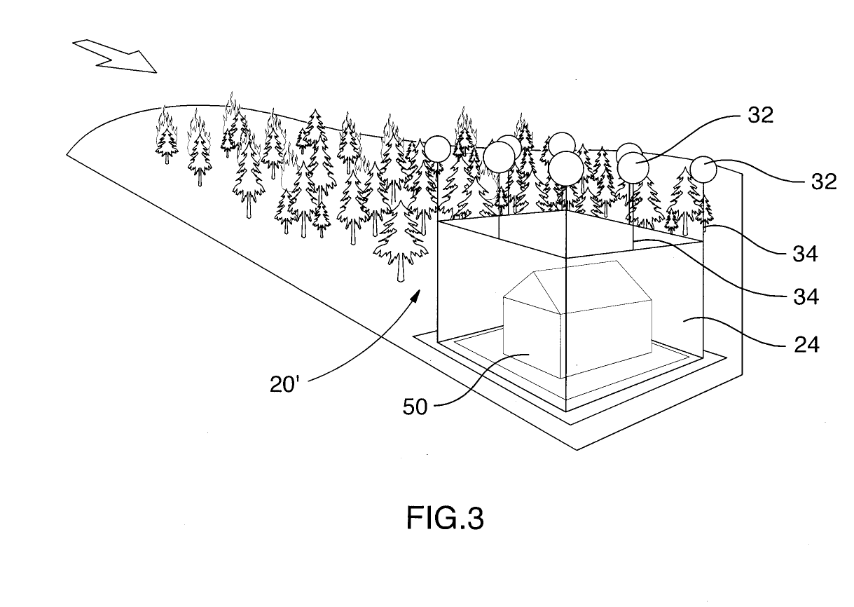

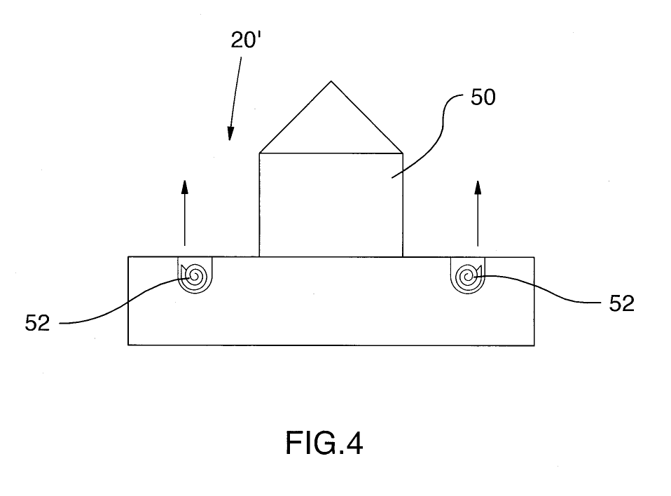

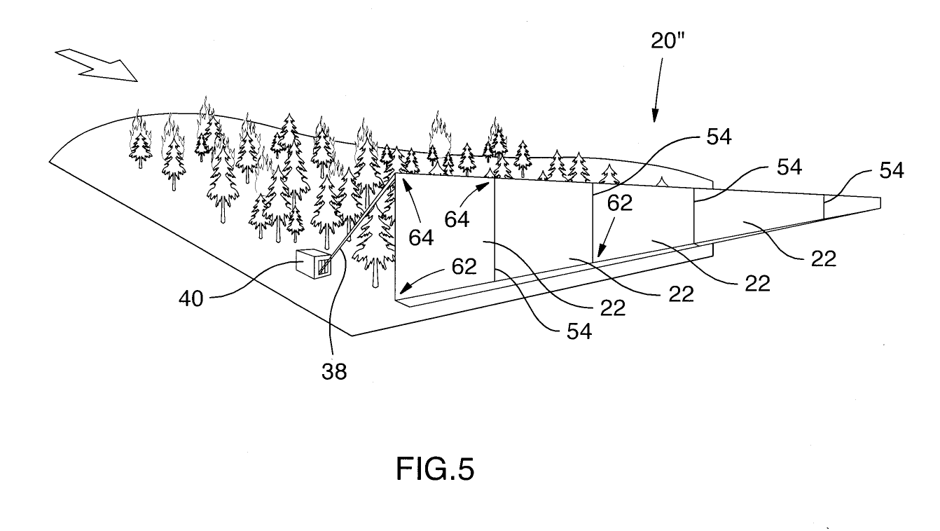

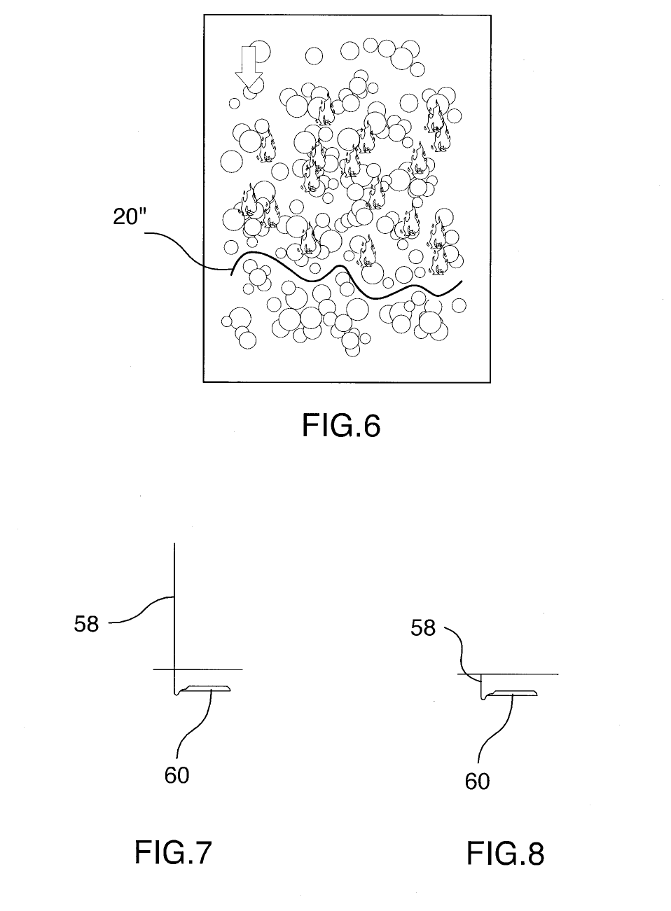

Five exemplary embodiments of the barrier apparatus of the present invention are shown in use in the figures, the first being shown in FIGS. 1-2 and designated with general reference 20, the second being shown in FIGS. 3-4 and designated with general reference 20′, the third being shown in FIGS. 5-6 and designated with general reference 20″, the fourth being shown in FIGS. 7-10 and designated with general reference 20′″ and the fifth being shown in FIG. 12 and being designated with general reference 20″″.

Turning initially to FIGS. 1-2, this apparatus 20 will be seen to comprise a panel 24 and a support apparatus 26. This panel 24 is constructed of flexible, fire/heat resistant material, for example, aromatic nylon of the type sold by Dupont Corporation under the trade-mark NOMEX®, and has a first end portion 30 and a second end portion 28, spaced-apart from one another.

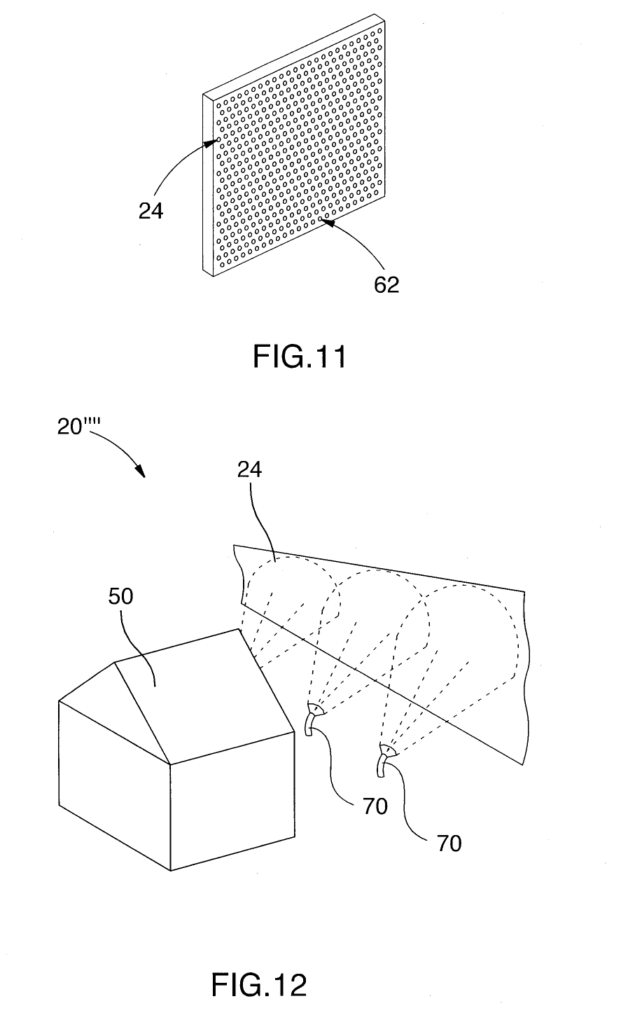

As seen in FIG. 11, this material is imperforate, i.e provided with a plurality of holes 62, to permit air flow.

Returning to FIG. 1, the panel 24 illustrated therein will be seen to be formed of three segments 22, but persons of ordinary skill in the art will readily understand that any number of segments may be employed, with the determination as to the number of panels used being merely a function of the lengths of panel-forming material available, the lengths of panel-forming material which can be manipulated with tools on hand and the length of the barrier to be constructed.

The support apparatus 26 comprises a plurality of balloons 32 filled with a lighter-than-air gas such as helium to be buoyant in air and connected by tethers 34 to the second end portion 28 of the panel 24 to cause said panel 24 to assume an upright position as shown, whereat it extends upwardly from said first end portion 30 to said second end portion 28.

Barrier apparatus 20 further comprises a mounting apparatus 42, a plurality of guys 38 and a plurality of winches 40. The mounting apparatus 42 is for operatively securing the first end portion 30 of said panel 24 at least adjacent to the ground in use, and in this illustrated embodiment takes the form of a skirt 36 portion extending from the first end portion 30 of the panel 24 and secured by stakes (not shown) to the ground. Each guy 38 has a free end 44 secured to the second end portion 28 of the panel 24 and a fixed end 46 operatively secured to the ground. As shown, the fixed end 46 is operatively secured to the ground via a respective winch 40, from which the guy 38 unspools to the free end 44.

This embodiment is intended for deployment in forests and the like. In use, segments 22 of the panel 24 are deployed between the area from which fire is expected to arrive and an area to be protected, the skirt 36 is staked in place, the winches 40 are ground-mounted on the windward side of the panel 24 and the guys 38 are secured to the second end portion 28 of the panel 24.

The various components can be delivered by truck, all-terrain vehicle or the like, or air-dropped. When the barrier 20 is to be erected, balloons 32 are tethered to the second end portion 28 of the panel 24 and inflated with a suitably non-combustible lighter-than air gas, i.e. helium in the embodiment as described, to urge the panel 24 towards the upright position as shown. As the panel 24 is raised (not shown), the winches 40 play out the guys 38 until such time as the panel 24 is in the upright position. At this point, the guys 38 are taut. The use of the winches 40 avoids the potential for tangling that might otherwise occur if the guys 38 were simply staked to the ground and left loose until use.

As persons of ordinary skill in the art will readily appreciate, guys 38, winches 40, balloons 32 and tethers 34 are all preferably constructed out of fire/heat resistant material, as same will be exposed to the same conditions as is the panel 24.

The second embodiment 20′ shown in FIGS. 3-4 is somewhat similar to that of FIGS. 1-2, in that tethered balloons 32 are employed to support the panel 24 in the upright position. However, whereas the panel 24 of FIGS. 1-2 is generally linear, or more particularly, serpentine, as evident when viewed overhead, to follow an irregular terrain, the panel 24 of FIGS. 3-4 forms a closed loop surrounding a structure 50, for example, a house. As well, whereas in FIGS. 1-2, the mounting apparatus is a skirt portion 36 staked to the ground, in FIGS. 3-4, the mounting apparatus comprises an underground roller 52, rotatably mounted in a conventional manner (not shown) in use to the ground, about which the panel 24 can be wound and from which the panel 24 is unwound when the support apparatus 26 causes said panel 24 to assume said upright position. This provides an unobtrusive arrangement, so as to permit a homeowner or the like to provide a readily-deployable fire barrier 20′, without detracting substantially from the aesthetics of the property when not in use.

The third embodiment 20″ of FIGS. 5-6 is generally similar to the embodiment of FIGS. 1-2, and is identified commensurately. However, whereas balloons 32 define the support apparatus of FIGS. 1-2, in FIGS. 5-6, a plurality of support poles 54 are provided, each, in use, being orientated upright, having a ground-engaging base 62 and having a top portion 64 from which the panel 24 is mechanically suspended.

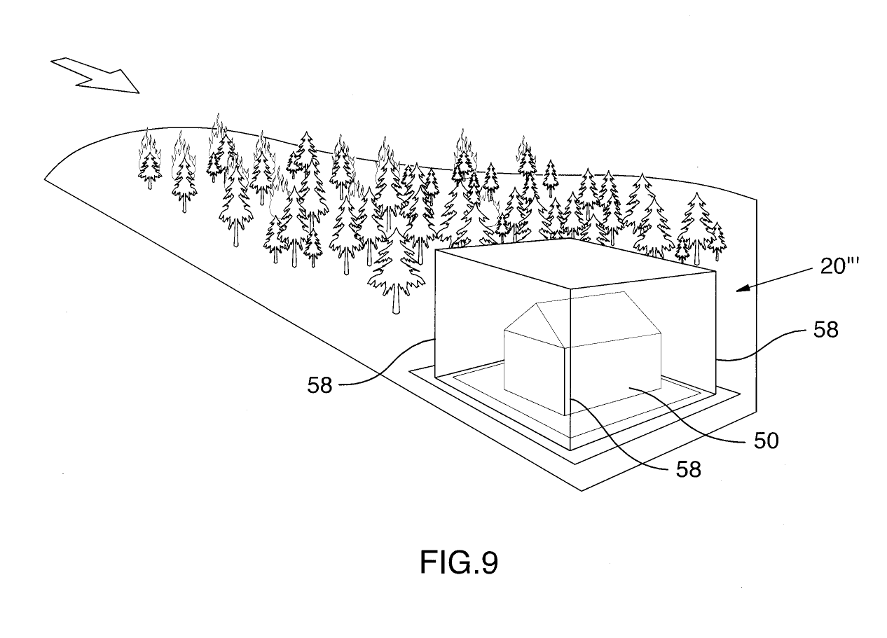

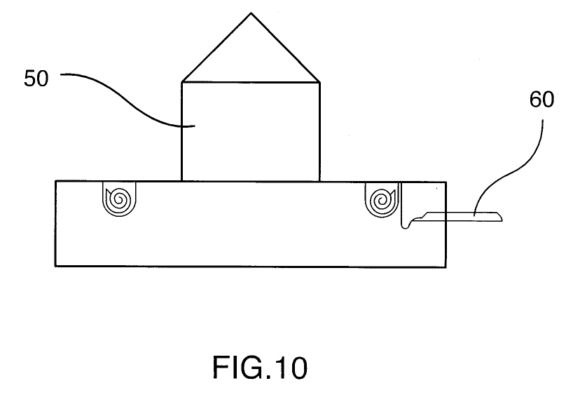

The fourth embodiment 20′″ of FIGS. 7-10 is generally similar to the embodiment of FIGS. 3-4, but instead of balloons 32 employs support poles 58 which, in response to the presence of smoke or heat, automatically telescopically extend to raise the panel 24, the motive force for such telescopic extension being provided by underground compressed gas tanks 60 which pressurize the interior of the supports 58 with air to effect extension of the support poles 58 from retracted positions, as shown in FIGS. 8 and 10, to extended positions as shown in FIGS. 7 and 9. In this event, suitable automated valves, not shown, would be employed on the tanks, and a smoke and/or heat sensor would be provided, communicating with the valves, to direct airflow to the support poles when needed.

The fifth embodiment 20″″ of FIG. 12 includes a panel 24 and support apparatus as earlier described (the support apparatus not being shown in this figure) and comprises water spray/sprinkler apparatus 70 adapted to automatically direct water on the panel 24 in response to heat or fire.

Whereas but five embodiments of the invention are herein shown and described, it will be evident that various modifications can be made.

For example, whereas winches are shown in the first and third exemplary embodiments, these can be omitted, with the guys secured directly to ground.

Similarly, the skirt of the first and third embodiments could readily be omitted. In this event, the first end portion of the panel could be directed staked to the ground, or at least in the context of the third embodiment, affixed to the pole bases. Further, whereas the use of stakes is described, it could also be possible to hold the skirt to the ground by weights, which could take the form of sandbags, rocks, logs, etc.

As well, whereas pneumatically-extendable support poles are shown in FIGS. 7-10, it will be readily understood that other actuation mechanisms are possible. Gases other than air could conceivably be used, for example, helium or other inert gases. Water, or other fluid, for example, could be utilized to fill the interior chambers in an analogous manner, to provide hydraulic actuation. As well, interior springs could be employed, and triggered by solenoid or the like, to mechanically deploy the support poles. Even motors, for example, electric motors, coupled to suitable gearing could be employed.

Additionally, whereas in the embodiment of FIGS. 4 and 10, a roller is provided and upon which the panel is wound, this can be omitted if desired.

Moreover, whereas helium is specified in the context of FIGS. 1-4, other non-combustible, lighter-than air gases could equally be employed for the balloons.

As well, whereas NOMEX material is used in the exemplary embodiments described, other heat/fire resistant materials may be employed. As well, the panels could potentially be made out of non fire-resistant substrate, covered with a fire retardant coating. It is contemplated that the water of FIG. 12 could serve as the fire retardant “coating” on an otherwise non fire-resistant panel, thus it should be specifically understood that, in this specification, “fire-resistant material” includes any material that is fire-resistant, whether such resistance flows from intrinsic characteristics of the material, such as NOMEX, or externalities, such as fire-resistant coatings or water sprays.

Advertisements may also be deployed on the panel.

As well, whereas as shown, the winches 40 are deployed, with respect to the panel 24 and the prevailing winds, upwind, such that the panel 24 normally remains upright in the face of such winds, it will be understood that guys 38 may be deployed on both sides of the panel 24, to better stabilize same, not only against wind directional changes, but also against air currents that may be induced by air flows associated with the heat generated by wildfires. Such an arrangement of guys could, in the context of the third and fourth exemplary embodiments, also reduce or avoid the need for the poles to have rigid connections to the ground.

Further, whereas the panel is indicated to be imperforate, so as to allow a limited amount of air flow and reduce wind loads on the support structure, it should be understood that solid panels could also be employed. As well, whereas in FIG. 11, the holes appear to be equally-spaced and sized, the ratio of open:closed space, i.e. the hole size and density, could increase towards the second end portion of the panel, since wind speeds would normally be higher away from ground level.

Finally, whereas but two basic applications are shown, it should be understood that the panels could be deployed in a variety of manners, including but not limited to:
Barriers can be deployed in permanent or semi-permanent installations, or rapidly-deployed for temporary use
Long, linear [which includes arcuate and serpentine) arrangements may be used in forests or the like, to provide fire breaks
Closed or semi-closed arrangements may be deployed around houses or other structures.
Mixtures of balloons, rigid support poles and telescopically-extendable support poles may be employed.

Accordingly, it should be understood that the invention is to be limited only by the accompanying claims, purposively construed.

1. A barrier apparatus for arresting the spread of fires, said barrier apparatus comprising:
a flexible panel of fire-resistant material having a first end portion and a second end portion, spaced-apart from one another; and
support apparatus for causing said panel to assume, in use, an upright position whereat it extends upwardly from said first end portion to said second end portion.

2. A barrier apparatus according to claim 1, further comprising mounting apparatus for operatively securing the first end portion of said panel at least adjacent to the ground in use.

3. A barrier apparatus according to claim 1, wherein the panel is imperforate.

4. A barrier apparatus according to claim 1, wherein the panel is fabric.

5. A barrier apparatus according to claim 1, wherein the panel is woven out of aromatic nylon.

6. A barrier apparatus according to claim 2, wherein the support apparatus comprises:
a plurality of balloons buoyant in air and tethered to the second end portion of the panel in use; and
a plurality of guys each having, in use, a free end secured to the second end portion of the panel and a fixed end operatively secured to the ground.

7. A barrier apparatus according to claim 6, wherein each guy unspools from a respective ground-secured winch to the free end thereof in use.

8. A barrier apparatus according to claim 1, wherein the support apparatus comprises a plurality of support poles each, in use, being orientated upright, having a ground-engaging base and having a top portion from which the second end portion of the panel is suspended.

9. A barrier apparatus according to claim 8, further comprising mounting apparatus for operatively securing the first end portion of said panel at least adjacent to the ground in use.

10. A barrier apparatus according to claim 9, further comprising a plurality of guys each, in use, having a free end secured to the second end portion of the panel and a fixed end operatively secured to the ground.

11. A barrier apparatus according to claim 10, wherein each guy is unspooled in use from a respective ground-secured winch to the free end thereof.

12. A barrier apparatus according to claim 1, wherein, in use, the support apparatus selectively causes said panel to assume said upright position.

13. A barrier apparatus according to claim 12, further comprising mounting apparatus for operatively securing the first end portion of said panel at least adjacent to the ground in use.

14. A barrier apparatus according to claim 12, wherein, in use, the support apparatus causes said panel to assume said upright position in response to the presence of smoke or heat.

15. A barrier apparatus according to claim 13, wherein the mounting apparatus comprises a roller, rotatably mounted in use to the ground, about which the panel can be wound and from which the panel is unwound when the support apparatus causes said panel to assume said upright position.

16. A barrier apparatus according to claim 15, wherein the support apparatus comprises:
a plurality of balloons tethered to the second end portion of the panel and adapted to, in use, selectively buoy the second end portion of the panel to urge the panel towards the upright position.

17. A barrier apparatus according to claim 16, further comprising:
a plurality of winches each secured to the ground in use and adapted to unspool, as said panel assumes said upright position, a respective guy coupled to the second end portion of the panel.

18. A barrier apparatus according to claim 15, wherein the support apparatus comprises a plurality of support poles each, in use, being orientated upright, having a ground-engaging base and having a top portion from which the second end portion of the panel is suspended, wherein the support poles extend telescopically to cause the panel to assume the upright position.

19. A barrier apparatus according to claim 18, further comprising a plurality of winches each secured to the ground in use and adapted to unspool, as said panel assumes said upright position, a respective guy coupled to the second end portion of the panel.

20. A barrier apparatus according to claim 1, further comprising water spray/sprinkler apparatus for automatically directing water onto the panel in response to heat or fire.
